(19) United States
(12) Patent Application Publication
(10) Pub. No.: US 2025/0292262 A1
(43) Pub. Date: Sep. 18, 2025

(54) ADAPTIVE SUPPORT GUIDANCE SYSTEMS AND METHODS

(71) Applicant: T-Mobile USA, Inc., Bellevue, WA (US)

(72) Inventors: Amina Noor, Sammamish, WA (US); Mohammad Mustafa Bari, Woodinville, WA (US)

(21) Appl. No.: 18/606,829

(22) Filed: Mar. 15, 2024

(51) Int. Cl. G06Q 30/015; G06F 40/35; G06F 40/40; G10L 15/04; H04M 3/493

(52) U.S. Cl. CPC G06Q 30/015; G06F 40/35; G06F 40/40; G10L 15/04; H04M 3/493

(57) ABSTRACT

A method can include receiving, from a customer, a request for a support encounter. A method can include determining a customer intent indicative of an issue experienced by the customer. A method can include routing the customer to a support agent based on the intent. A method can include generating, using a first large language model, summaries of previous support encounters. A method can include providing the summaries to the support agent. A method can include determining, based on the intent and/or the summaries, one or more support documents related to the issue. A method can include generating, using a second large language model, a summary of each of the support documents, wherein an input to the second large language model comprises a support document. A method can include providing the generated summaries of the support documents to the support agent for use in mitigating the issue.

### BACKGROUND

Conventionally, when a customer calls or otherwise interacts with support personnel (e.g., through e-mail, text-based chat, in store, etc.), the customer can provide some input as to what issue they are experiencing, for example by selecting from a dropdown list, selecting from several choices offered by a chatbot, selecting from a telephone menu, and so forth. However, these options are typically limited, and customers can be routed to someone who is unable to resolve their issue. In some cases, customers may find such interactions frustrating and press “0” or type a word such as “representative” into a text input to reach a human or otherwise take measures to reach a live customer support representative without providing a clear indication of the reason they are reaching out to customer support.

Poor call routing can result in wasted time and expense for the telecommunications service, frustrate the customer, and so forth. For example, a customer may become frustrated as they are transferred from one customer support representative to another until they reach someone who can help with their issue. Handoffs consume valuable customer support time, can result in dropped support calls, and so forth.

In some cases, a customer support representative can walk a customer through troubleshooting steps but may not resolve the customer's issue, resulting in the customer calling back or otherwise having another interaction with customer support. In some cases, a customer support representative may not be aware of the customer's past interactions with customer service, for example because such information is not available or because it is not presented in a form that can be readily ingested and understood while engaging in live support with the customer. As a result, the customer service representative can fail to fully understand the customer's issue, can repeat troubleshooting steps that have already been tried, and so forth, resulting in wasted time and customer frustration. Accordingly, there is a need for improved customer support solutions that can improve the customer support experience.

### BRIEF DESCRIPTION OF THE DRAWINGS

Detailed descriptions of implementations of the present invention will be described and explained through the use of the accompanying drawings.

FIG. 1 is a block diagram of an example transformer.

FIG. 2 is a flowchart of an example method for summarizing customer encounter data according to some implementations.

FIG. 3 is a flowchart of an example method for routing a customer support interaction based on customer intent according to some implementations.

FIG. 4 is a flowchart of an example method for optimizing a customer support interaction according to some implementations.

FIG. 5 is a flowchart of an example method for determining and reacting to customer sentiment according to some implementations.

FIG. 6 is a flowchart of an example method for providing guidance to a support agent during a support encounter and updating one or more machine learning models based on feedback from the support agent according to some implementations.

FIG. 7 is a flowchart of an example method for receiving post-support feedback from a customer and updated one or more machine learning models according to some implementations.

FIG. 8A illustrates an example approach to multi-modal machine learning that uses early or intermediate fusion according to some implementations.

FIG. 8B illustrates an example approach to multi-modal machine learning that uses late fusion according to some implementations.

FIG. 9 is a block diagram that illustrates an example of a computer system 1000 in which at least some operations described herein can be implemented.

The technologies described herein will become more apparent to those skilled in the art from studying the Detailed Description in conjunction with the drawings. Embodiments or implementations describing aspects of the invention are illustrated by way of example, and the same references can indicate similar elements. While the drawings depict various implementations for the purpose of illustration, those skilled in the art will recognize that alternative implementations can be employed without departing from the principles of the present technologies. Accordingly, while specific implementations are shown in the drawings, the technology is amenable to various modifications.

### DETAILED DESCRIPTION

The description and associated drawings are illustrative examples and are not to be construed as limiting. This disclosure provides certain details for a thorough understanding and enabling description of these examples. One skilled in the relevant technology will understand, however, that the invention can be practiced without many of these details. Likewise, one skilled in the relevant technology will understand that the invention can include well-known structures or features that are not shown or described in detail, to avoid unnecessarily obscuring the descriptions of examples.

Providing quality customer service is important for ensuring that customers remain content with the services they receive. Poor customer service can result in customer attrition (“churn”), repeated calls to customer service, reputational damage, and so forth. Significant expenses can be incurred when customers receive poor service. For example, if a call has to be routed to multiple customer service representatives before an issue is resolved, or if a customer has to make multiple calls, customer satisfaction can be reduced, significant demand can be placed on customer service resources, which can require greater staffing, result in longer wait times for other customers, and so forth.

Providing quality customer service can be especially difficult in some industries. For example, wireless telecommunications companies may offer a variety of services (e.g., wireless voice, wireless data, wireless high speed home internet, international calling, international data, and so forth), have customers using a wide variety of hardware (e.g., high speed internet (HSI) gateways, smartphones, tablets, smartwatches, laptops, etc.) and software (e.g., iOS, iPadOS, watchOS, Android, Windows, and so forth), and so forth. Customers can contact support regarding hardware issues, software issues, network issues, billing issues, and so forth. The issues experienced by customers can depend on the services they are subscribed to, the hardware they are using, the software they are using, their geographic location, and so forth. For example, in a cellular network, there may be an outage in one area because of adverse weather, network maintenance, high demand due to an emergency or event, and so forth, while other geographic locations may be unaffected. As another example, one service (e.g., voice calling) may be functioning normally while another (e.g., wireless high speed internet) may be experiencing issues. In another example, a customer may experience an issue with the hardware or software of their smartphone or other device. In other cases, customers may be calling because they have a billing inquiry, would like to add or remove a service (e.g., to add wireless hotspot coverage or international data when traveling), and so forth.

As customers of a wireless telecommunications company are generally subscribed to a service, customers can receive periodic bills (e.g., monthly). These bills can fluctuate based on usage, travel, and so forth. Even if a customer is experiencing no issues with the functionality of their service, they may nonetheless call to inquire about an unusually high bill, to add or remove a line or device from their account, to add or remove services, and so forth. Customers may call to inquire about high billing or to arrange for coverage while traveling. For example, a customer may call before taking a trip abroad to obtain information about international roaming, or may call after a trip abroad to understand international roaming billing charges.

As described above, customers can seek support for a wide range of issues. It can be important to direct a customer to an appropriate support representative for the issue the customer is facing. The right support representative can resolve the customer's issue right away, reduce overall call times, reduce customer service costs, and so forth. Customer satisfaction can be increased, customer frustration can be reduced, and so forth. When a customer is directed to a support representative who cannot assist them in resolving their issue (e.g., a customer with a billing issue is directed to a support representative who is trained to address cellular phone hardware issues, or a high speed home internet customer is directed to a service representative who deals mostly with smartphone issues), the customer can be transferred to another agent. The transfer process can sometimes span multiple support agents in an effort to locate an agent who can assist the customer with their issue. There can be a significant time and cost associated with such transfers, and customers can be left with a negative impression that can make them more likely to churn, more likely to speak negatively of the company, and so forth.

In some cases, a customer may be experiencing an issue and can contact support for assistance. The support interaction can end, and the customer's issue can seemingly be resolved. However, the customer may call back later experiencing the same issue or a similar issue. Typically, customers experience a limited number of issues at any given time. Thus, if a customer calls back within a short time period of their previous call (e.g., within a few days), it can be likely that the customer is calling about the same issue, though this is not necessarily the case. For example, a customer may call for help activating a new smartphone, and may subsequently call back to inquire about upgrading their plan, adding a smartwatch, etc.

In some implementations, customer calls can be routed based on a determined intent. The determined intent can be based on, for example, information provided by the customer (e.g., using a phone-based menu, dropdown selection on a web site, set of options offered by a chatbot, etc.), information about previous calls, information about known network issues, weather information in the customer's location, information about large events in the customer's location (e.g., sporting events, concerts, etc.) that can result in heavy network demand, ongoing emergencies in the customer's location, known outages or service interruptions in the customer's location, and so forth.

Systems and methods for determining call intent are described in co-pending application Ser. No. 18/606,140 filed Mar. 15, 2024, the contents of which are hereby incorporated by reference herein in their entirety and for all purposes as if set forth fully herein.

In some embodiments, call intent can be determined based on prior support summaries as described herein.

In some cases, one or more possible intents can be eliminated or assigned a lower likelihood. For example, if a customer called about poor data speeds during a large sporting event, and the event has since concluded, a subsequent call may be unlikely to be about the same issue. Similarly, if the customer contacted support regarding a well-known issue with a well-defined remediation, it may be unlikely that the customer is contacting support about the same issue again, although in such cases it is possible that a customer may call multiple times, for example if they have multiple devices and need assistance solving the issue on an additional device, or if the customer or a support agent made an error while performing steps to remediate the issue.

When a call is routed based on customer intent, the customer can more quickly reach a support agent who can assist the customer with their issue. However, support agents can struggle to understand the customer's past interactions, the reason for the call, and so forth. Even if a support agent inquires about the customer's past support issues or troubleshooting steps, the customer may struggle to explain the issue and/or past troubleshooting actions, and even when such information is provided, the support agent can struggle to identify which troubleshooting procedures were followed. For example, for any given issue, there can be one or more support documents that provide guidance to help the support agent resolve the issue. It may not be immediately clear to the support agent which of multiple support documents were followed during previous support encounters. In some implementations, a machine learning model (e.g., a large language model (LLM)) can be used to summarize past interactions. For example, an LLM can be used to summarize past chats, emails, calls (e.g., using transcriptions of calls), in-person support encounters (e.g., when a customer seeks support at a physical store), and so forth. Summaries can be significant because, while a support agent may have access to information about past support encounters, such information can be too long, too complex, etc., for the support agent to read and understand while actively engaged in providing support to the customer. In some implementations, support summaries can provide short, easily digestible information about a customer's past support encounters. In some implementations, summaries can be limited in size, for example 50 characters or less, 100 characters or less, 200 characters or less, and so forth. In some implementations, summaries can be as little as a single word or a few words that characterize the issue for which the customer contacted support.

In some cases, there may be little or no information about past customer support encounters, or past encounters may have occurred a sufficient time period ago (e.g., a month or more) such that they are likely unrelated to the customer's current issue. In some implementations, a support agent can be provided with a summary or other information about reasons the customer may be contacting support. In some implementations, this information can be gathered from public data sources, internal data sources, and so forth. For example, public information can include information about ongoing emergencies, sporting events, concerts, festivals, protests, adverse weather, power outages, and so forth in a particular area near where the customer is located. Internal data can include, for example, information about known problems on a telecommunications network, such as cell sites that are out of service or experiencing issues, known high demand on a cell site, planned maintenance outages, planning service upgrades, and so forth.

In some implementations, support agents can use this information to help troubleshoot a customer's issue or simply to inform the customer of the reason they are experiencing the issue. In some cases, the support agent can use this information to advise the customer of a time when the issue is expected to be resolved. For example, connectivity or bandwidth issues may be expected to pass once a sporting event ends and the crowd disperses, once a storm passes, and so forth.

In some cases, call intent can be determined based on factors such as, for example, the release of a software update for a smartphone, the release of new phone hardware, the release of a configuration update for a smartphone, and so forth. In some implementations, information about a customer's hardware, software, and so forth can be used to determine call intent, determine appropriate support documents, route the call to an appropriate support agent, and so forth. For example, some information about the customer's hardware, software, or both may be stored in a database maintained by the telecommunications service. For example, services typically maintain a record of IMEIs, MAC addresses, and/or other identifiers associated with customer equipment. This information can be used to determine manufacturer, model, and so forth. In some cases, such information can be used to infer additional information. For example, if an IMEI corresponds to an iPhone, the operating system can be inferred to be iOS. If the IMEI corresponds to the latest iPhone model, the operating system version can be inferred to be the most recent major release of the operating system. In some cases, device information can be used to limit possible issues. For example, a user with an older smartphone that no longer receives updates or a poorly supported new phone that has never run an up to date operating system version can be inferred to be running an operating system that is within a certain range of versions. This information can help to narrow down possible causes of an issue the user is experiencing. For example, if an operating system issue affects only the latest version of the operating and it is determined that the user's device cannot run the latest version, that operating system version can be eliminated as a possible cause of the user's issue.

In some implementations, information about the customer's services can be used to determine call intent. For example, if a customer has both a cell phone plan and home internet, and there is a known issue with home internet service (e.g., slow speeds in the customer's neighborhood), the customer can be automatically routed to a support agent for home internet.

In some implementations, billing information can be used to determine customer call intent. For example, if it is the end of a billing cycle and the customer has a bill that is higher than normal, the customer's intent may be determined to be a billing inquiry. Similarly, a customer who has been traveling abroad and has accumulated a bill that is higher than usual may call or otherwise contact support to inquire about international talk or data charges.

While routing calls based on intent and providing summaries of past support encounters can significantly improve the support experience for both customers and support agents, customers and support agents may still encounter some friction, frustration, and so forth when attempting to resolve or mitigate an issue. Providing summaries of past interactions and/or information about current issues affecting service can be of great significance, but even then, resolution of the customer's issue may not be straightforward. For example, if a customer calls in about a particular issue they are experiencing (such as dropped calls or poor data speeds), there may be numerous causes and numerous solutions may be applicable to the customer's issue. There can be multiple troubleshooting documents that may be relevant to the customer's issue, but a support agent may struggle to identify which documents are most relevant, what is contained in the documents, specific steps in the documents, and so forth. These issues can be especially pronounced because a support agent may be trying to understand multiple documents under time-constrained conditions as the customer is waiting for a response or next steps from the support agent. Thus, support agents may only have time to quickly skim documents and may miss important information.

In some implementations, a machine learning model (e.g., an LLM) can be used to summarize information contained in support documents. For example, an LLM can summarize what a document pertains to, extract specific troubleshooting steps from the document, and so forth. These summaries, extracted steps, and so forth can be provided to a support agent so that the support agent can quickly understand what different documents relate to and the specific steps contained in each document. This can reduce the time that a customer must wait on hold while the support agent reviews the document, can reduce errors (e.g., the support agent may be less likely to make an error if they are provided with a short summary and specific steps as opposed to a long document that they skim), and so forth.

In some implementations, a machine learning model (e.g., an LLM) can be configured to identify support documents based on determined customer intent, information about the customer's services, information about the customer's hardware and/or software, information about the customer's bill, and so forth. For example, as discussed above, in some cases the customer's smartphone hardware and/or software can be known. This information can be used to select support documents that may be helpful in resolving or mitigating the customer's issue. For example, if a customer is known to be running the latest version of iOS, support documents related to Android smartphones can be excluded, as can support documents that only apply to older versions of iOS.

In some implementations, a system can be configured to adapt recommended troubleshooting steps based on previous encounters with the customer or with other customers who have experienced the same issue. For example, if there are four documents that relate to resolving and/or mitigating possible causes of the customer's issue, and the customer has tried following the steps in the first two documents during a previous support encounter, the system can instruct the support agent to skip the first two documents and instead try the troubleshooting steps in the third and fourth documents. In some cases, the customer's issue may not have been resolved because the customer did not follow the instructions in the first or second document correctly, because a previous support agent provided incorrect instructions to the customer, and so forth. Thus, the first two documents can still be available and can still be used by the support agent, but may be tried after attempting troubleshooting steps that have not previously been tried. Such an approach can reduce the total time it takes to resolve a customer's issue and can result in an improved customer experience. For example, a customer calling back for the same issue can become frustrated or angry if they are asked to repeat steps they have already tried during a previous support encounter. The customer may feel that the support agents do not understand the customer's issue, do not talk to each other, are wasting the customer's time, and so forth.

During a support encounter, it can be important to react appropriately to a customer. For example, a customer may be agitated when they call, may become agitated during a call, may be calmed or pleased in response to their issue being resolved, and so forth. In some cases, support agents can react to the customer's behavior, language, etc., in ways that may be counterproductive. For example, it can be important for a support agent to acknowledge the customer's frustration, take measures to reassure the customer that their issue is important, and so forth. In some implementations, sentiment analysis can be used to determine a customer's sentiment (e.g., mood) during a support encounter or prior to the customer being connected with a support agent (e.g., for a voice-based phone menu, the customer's sentiment can be determined to be angry if the customer yells into the phone to state their problem, uses coarse language, demands an operator, and so forth). The customer's sentiment can be used to provide guidance to the support agent, such as suggesting words or phrases to use when speaking with the customer, reminding the support agent to remain calm and professional, and so forth.

Various approaches to sentiment analysis can be used to determine the customer's sentiment. Some implementations can determine if a customer's sentiment is positive, negative, or neutral. Some implementations can determine more nuanced sentiment, such as anger, frustration, indifference, shock, and so forth.

In some implementations, the words spoken or typed by a customer can be used to determine sentiment. For example, specific phrases, words, sentence length, and so forth can be used to determine sentiment. In the case of voice data, speech recognition can be used to convert audio to text, and a sentiment analysis engine can process the text to determine intent. In some cases, the sentiment analysis engine can include a machine learning model or multiple machine learning models. For example, in some implementations, the sentiment analysis engine can include a classifier model, which can include a convolutional neural network.

While text-based sentiment analysis can be of great value, there can be some limitations. For example, context can be important for understanding the sentiment being expressed. For example, when a customer is asked a question, the sentiment of their response can depend on the specific question asked. Additionally, text-based sentiment analysis can struggle to understand idioms, sarcasm, and so forth. While sarcasm for example may be apparent when listening to a person's speech, it may not be clear that the person was being sarcastic when their speech is converted to text.

In some implementations, audio can be used to determine sentiment. For example, a customer's pitch, amplitude, speed, tone of voice, and so forth can indicate the customer's sentiment. For example, loud volume, loud breathing, fast speaking, and so forth can indicate that the user is upset, while slow speech may indicate that the user is frustrated and losing hope that the issue will be resolved. In some implementations, Mel Frequency Cepstral Coefficients (MFCCs) can be calculated from an audio sample (e.g., the customer's voice) and used to determine sentiment, for example using a machine learning model (e.g., a neural network). In some implementations, MFCCs can be used as identifying features for a machine learning model (e.g., a neural network) to determine sentiment.

In some implementations, a customer's facial expressions, hand gestures, and so forth can be used to determine sentiment. For example, during a video chat or in-store support encounter, the customer's facial expressions, arm movements, hand movements, and so forth can be monitored and used to determine sentiment. For example, a machine learning model can be trained to identify when the customer is furrowing their brow, waiving their hands, hunching their shoulders, making sudden, quick movements, frowning, smiling, laughing, and so forth.

As mentioned above with respect to text analysis for determining sentiment, it can be difficult to determine sentiment with limited information, for example based solely on audio without regard to the actual content being spoken by the customer. For example, a customer may be speaking fast or at a higher pitch because they are angry or because they are excited. Accordingly, it can be beneficial to use multiple modes to determine sentiment (e.g., text and audio features). For example, text analysis and audio analysis outputs can be inputs to a multi-modal attention model used to determine a customer's sentiment.

Multi-modal machine learning models can be designed to process data from different modalities, for example text, audio, video, and so forth. Information from the different modalities can be integrated to reach a more comprehensive understanding of input data. As a simple example, consider recognizing words spoken in a video. If only the audio track is used, some words can be missed or misinterpreted, for example due to poor sound quality, background noise, and so forth. In a multi-modal approach, a model can consider both the audio track and the video track, which can improve results. For example, if sound occurs while the speaker's mouth is closed, that sound may not be considered when determining what the speaker said. If the sound is unclear, the speaker's lip movements can be used to get a better understanding of what the speaker said.

A multi-model model can have subnetworks used to process each modality. In some embodiments, a model can include an integration layer. The integration layer can fuse, concatenate, or otherwise integrate the different modalities together. In some implementations, the integration layer can use an attention mechanism.

The approaches described herein can increase customer satisfaction, reduce resolution times, improve support agent productivity, reduce costs, and so forth. However, the approaches herein may work better for some types of issues than others or for some specific problems than others. For example, the approaches described herein may be highly beneficial for addressing known issues such as heavy network loads, hardware releases (e.g., a large number of callers can be expected to be asking for help activating a new device), or software updates, but may not perform as well for rarer issues or issues that are harder to predict, such as a hardware problem with a customer's device.

In some implementations, one or more models can undergo periodic or continuous learning to improve performance. In some implementations, support agents can be provided with a post-support survey. The post support survey can ask one or more questions, such as how effective the summaries of prior encounters were, how effective document summaries were, how effective guidance was during the encounter, and so forth. In some implementations, support agents can provide feedback on a numerical scale, letter scale, or other scale that can be readily translated to a numerical representation. In some implementations, support agents can, alternatively or additionally, provide free form textual input. In some implementations, an LLM or other model can be used to extract information from the textual input, which can be used to gauge usefulness.

In some implementations, customers can be provided with a post-support survey and can rate their support experience. For example, the customer can be asked to rate the issue resolution time, friendliness of the support agent, helpfulness of the support agent, effectiveness of the support, and so forth. The survey could be, for example, a text-message based survey, phone-based survey, web-based survey, or any other type of survey. The customer's feedback can be used to update one or more machine learning models.

While support agents can respond to surveys as part of their job, customers may have little motivation to respond to a survey. Thus, surveys may be biased. For example, it could be the case that those who are unsatisfied tend to respond more than those who were satisfied as they wish to vent their frustration, or it could be the case that satisfied customers are more likely to stay on the line after a call to provide positive feedback to a support agent. Unbalanced responses can lead to problems in training machine learning models. For example, if unsatisfied customers are much more likely to respond than satisfied customers, model performance can appear significantly worse than it actually is. For example, in the context of supervised learning, as described in more detail herein, training data can be labeled based on survey responses. Training data can be over- or under-representative of negative or positive outcomes of support encounters, which can lead to poor training results. In some implementations, random oversampling or undersampling can be used to mitigate the effects of responses that over-represent either satisfied or dissatisfied customers.

Bias in machine learning models can be a concerning issue. Bias can arise from biases present in training data, in model design, and so forth. As just one example, a sentiment model may inaccurately determine that certain groups of people are angry or upset when they are not, a model for summarizing customer inputs (e.g., things the customer said or wrote) may inaccurately summarize certain customer inputs if it was not trained using samples representative of how the customer speaks or writes. For example, a model may struggle with language from a non-native speaker, someone from certain regions, etc. Thus, it can be important to ensure that data used for training machine learning models is representative. For example, in the context of customer sentiment analysis, it can be important to ensure that machine learning models are trained using data that adequately represents the full spectrum of customers.

### Machine Learning Models

A “model,” as used herein, can refer to a construct that is trained using training data to make predictions or provide probabilities for new data items, whether or not the new data items were included in the training data. For example, training data for supervised learning can include items with various parameters and an assigned classification. A new data item can have parameters that a model can use to assign a classification to the new data item. As another example, a model can be a probability distribution resulting from the analysis of training data, such as a likelihood of an n-gram occurring in a given language based on an analysis of a large corpus from that language. Examples of models include neural networks, support vector machines, decision trees, Parzen windows, Bayes, clustering, reinforcement learning, probability distributions, decision trees, decision tree forests, and others. Models can be configured for various situations, data types, sources, and output formats.

In some implementations, a classifier model (e.g., configured to classify support encounter summaries as useful or not, to classify support document summaries as useful or not, or to classify guidance as useful or not, etc.) can be a neural network with multiple input nodes that receive data (e.g., support encounter data) and corresponding labels (e.g., effective or not effective). The input nodes can correspond to functions that receive the input and produce results. These results can be provided to one or more levels of intermediate nodes that each produce further results based on a combination of lower-level node results. A weighting factor can be applied to the output of each node before the result is passed to the next layer node. At a final layer, (“the output layer”) one or more nodes can produce a value classifying the input. In some implementations, such neural networks, known as deep neural networks, can have multiple layers of intermediate nodes with different configurations, can be a combination of models that receive different parts of the input and/or input from other parts of the deep neural network, or are convolutions-partially using output from previous iterations of applying the model as further input to produce results for the current input.

A machine learning model can be trained using supervised learning, where the training data includes support encounter data (e.g., input provided by a customer such as text and/or audio, previous encounter summaries, support document summaries, guidance provided to a support agent) as input and a desired output, such as a rating of the usefulness of encounter summaries, document summaries, and/or guidance provided to a support agent. A representation of the input data can be provided to the model. Output from the model can be compared to the desired output for that input data (e.g., if a support agent indicated document summaries were useful, the model should identify the document summaries as useful) and, based on the comparison, the model can be modified, such as by changing weights between nodes of the neural network or parameters of the functions used at each node in the neural network (e.g., applying a loss function). After modifying the model to achieve a desired level of performance, the model can be trained to evaluate new inputs.

### Transformer for Neural Network

To assist in understanding the present disclosure, some concepts relevant to neural networks and machine learning (ML) are discussed herein. Generally, a neural network comprises a number of computation units (sometimes referred to as “neurons”). Each neuron receives an input value and applies a function to the input to generate an output value. The function typically includes a parameter (also referred to as a “weight”) whose value is learned through the process of training. A plurality of neurons may be organized into a neural network layer (or simply “layer”) and there may be multiple such layers in a neural network. The output of one layer may be provided as input to a subsequent layer. Thus, input to a neural network may be processed through a succession of layers until an output of the neural network is generated by a final layer. This is a simplistic discussion of neural networks and there may be more complex neural network designs that include feedback connections, skip connections, and/or other such possible connections between neurons and/or layers, which are not discussed in detail herein but which are known to those of skill in the art.

A deep neural network (DNN) is a type of neural network having multiple layers and/or a large number of neurons. The term DNN may encompass any neural network having multiple layers, including, for example, convolutional neural networks (CNNs), recurrent neural networks (RNNs), multilayer perceptrons (MLPs), Generative Adversarial Networks (GANs), Variational Autoencoders (VAEs), and Auto-regressive Models, among others.

DNNs are often used as ML-based models for modeling complex behaviors (e.g., human language, image recognition, object classification) in order to improve the accuracy of outputs (e.g., more accurate predictions) such as, for example, as compared with models with fewer layers. In the present disclosure, the term “ML-based model” or more simply “ML model” may be understood to refer to a DNN. Training an ML model refers to a process of learning the values of the parameters (or weights) of the neurons in the layers such that the ML model is able to model the target behavior to a desired degree of accuracy. Training typically requires the use of a training dataset, which is a set of data that is relevant to the target behavior of the ML model.

As an example, to train an ML model that is intended to model human language (also referred to as a language model), the training dataset may be a collection of text documents, referred to as a text corpus (or simply referred to as a corpus). The corpus may represent a language domain (e.g., a single language), a subject domain (e.g., scientific papers or a company's internal documentation), and/or may encompass another domain or domains, be they larger or smaller than a single language or subject domain. For example, a relatively large, multilingual, and non-subject-specific corpus may be created by extracting text from online webpages and/or publicly available social media posts. Training data may be annotated with ground truth labels (e.g., each data entry in the training dataset may be paired with a label) or may be unlabeled.

Training an ML model generally involves inputting into an ML model (e.g., an untrained ML model) training data to be processed by the ML model, processing the training data using the ML model, collecting the output generated by the ML model (e.g., based on the inputted training data), and comparing the output to a desired set of target values. If the training data is labeled, the desired target values may be, for example, the ground truth labels of the training data. If the training data is unlabeled, the desired target value may be a reconstructed (or otherwise processed) version of the corresponding ML model input (e.g., in the case of an autoencoder), or can be a measure of some target observable effect on the environment (e.g., in the case of a reinforcement learning agent). The parameters of the ML model are updated based on a difference between the generated output value and the desired target value. For example, if the value outputted by the ML model is excessively high, the parameters may be adjusted so as to lower the output value in future training iterations. An objective function is a way to quantitatively represent how close the output value is to the target value. An objective function represents a quantity (or one or more quantities) to be optimized (e.g., minimize a loss or maximize a reward) in order to bring the output value as close to the target value as possible. The goal of training the ML model typically is to minimize a loss function or maximize a reward function.

The training data may be a subset of a larger data set. For example, a data set may be split into three mutually exclusive subsets: a training set, a validation (or cross-validation) set, and a testing set. The three subsets of data may be used sequentially during ML model training. For example, the training set may be first used to train one or more ML models, each ML model having, for example, a particular architecture, having a particular training procedure, being describable by a set of model hyperparameters, and/or otherwise being varied from the other of the one or more ML models. The validation (or cross-validation) set may then be used as input data into the trained ML models to, for example, measure the performance of the trained ML models and/or compare performance between them. Where hyperparameters are used, a new set of hyperparameters may be determined based on the measured performance of one or more of the trained ML models, and the first step of training (i.e., with the training set) may begin again on a different ML model described by the new set of determined hyperparameters. In this way, these steps may be repeated to produce a more performant trained ML model. Once such a trained ML model is obtained (e.g., after the hyperparameters have been adjusted to achieve a desired level of performance), a third step of collecting the output generated by the trained ML model applied to the third subset (the testing set) may begin. The output generated from the testing set may be compared with the corresponding desired target values to give a final assessment of the trained ML model's accuracy. Other segmentations of the larger data set and/or schemes for using the segments for training one or more ML models are possible.

Backpropagation is an approach for training an ML model. Backpropagation is used to adjust (also referred to as update) the value of the parameters in the ML model, with the goal of optimizing the objective function. For example, a defined loss function is calculated by forward propagation of an input to obtain an output of the ML model and a comparison of the output value with the target value. Backpropagation calculates a gradient of the loss function with respect to the parameters of the ML model, and a gradient algorithm (e.g., gradient descent) is used to update (i.e., “learn”) the parameters to reduce the loss function. Backpropagation is performed iteratively so that the loss function is converged or minimized. Other techniques for learning the parameters of the ML model may be used. The process of updating (or learning) the parameters over many iterations is referred to as training. Training may be carried out iteratively until a convergence condition is met (e.g., a predefined maximum number of iterations has been performed, or the value outputted by the ML model is sufficiently converged with the desired target value), after which the ML model is considered to be sufficiently trained. The values of the learned parameters may then be fixed, and the ML model may be deployed to generate output in real-world applications (also referred to as “inference”).

In some examples, a trained ML model may be fine-tuned, meaning that the values of the learned parameters may be adjusted slightly in order for the ML model to better model a specific task. Fine-tuning of an ML model typically involves further training the ML model on a number of data samples (which may be smaller in number/cardinality than those used to train the model initially) that closely target the specific task. For example, an ML model for generating natural language that has been trained generically on publicly-available text corpora may be fine-tuned by further training using specific training samples, for example. The specific training samples can be used to generate language in a certain style or in a certain format. For example, the ML model can be trained to generate a blog post having a particular style and structure with a given topic.

Some concepts in ML-based language models are now discussed. It may be noted that, while the term “language model” has been commonly used to refer to a ML-based language model, there could exist non-ML language models. In the present disclosure, the term “language model” may be used as shorthand for an ML-based language model (i.e., a language model that is implemented using a neural network or other ML architecture), unless stated otherwise. For example, unless stated otherwise, the “language model” encompasses large language models (LLMs).

A language model may use a neural network (typically a DNN) to perform natural language processing (NLP) tasks. A language model may be trained to model how words relate to each other in a textual sequence, based on probabilities. A language model may contain hundreds of thousands of learned parameters or in the case of a large language model (LLM) may contain millions or billions of learned parameters or more. As non-limiting examples, a language model can generate text, translate text, summarize text, answer questions, write code (e.g., Python, JavaScript, or other programming languages), classify text (e.g., to identify spam emails or tag documents based on their content), create content for various purposes (e.g., social media content, factual content, or marketing content), or create personalized content for a particular individual or group of individuals. Language models can also be used for chatbots (e.g., virtual assistants).

In recent years, there has been interest in a type of neural network architecture, referred to as a transformer, for use as language models. For example, the Bidirectional Encoder Representations from Transformers (BERT) model, the Transformer-XL model, and the Generative Pre-trained Transformer (GPT) models are types of transformers. A transformer is a type of neural network architecture that uses self-attention mechanisms in order to generate predicted output based on input data that has some sequential meaning (i.e., the order of the input data is meaningful, which is the case for most text input). Although transformer-based language models are described herein, it should be understood that the present disclosure may be applicable to any ML-based language model, including language models based on other neural network architectures such as recurrent neural network (RNN)-based language models.

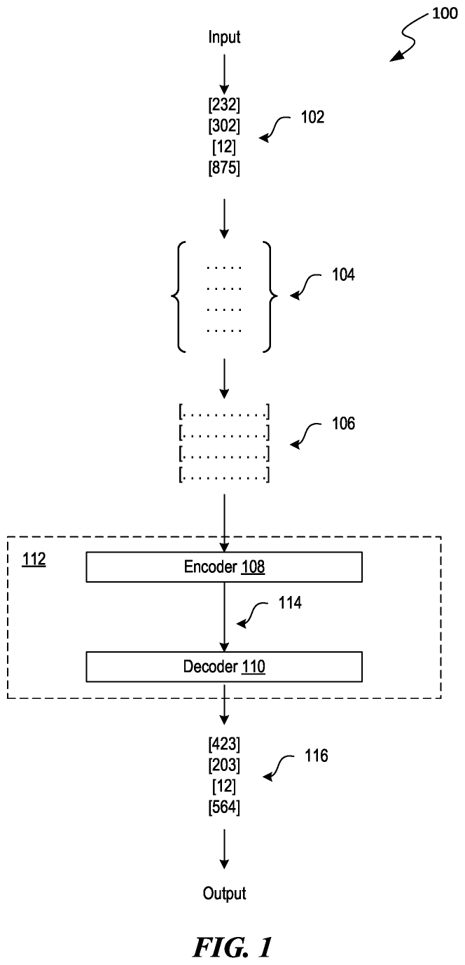

FIG. 1 is a block diagram of an example transformer 112. A transformer is a type of neural network architecture that uses self-attention mechanisms to generate predicted output based on input data that has some sequential meaning (i.e., the order of the input data is meaningful, which is the case for most text input). Self-attention is a mechanism that relates different positions of a single sequence to compute a representation of the same sequence. Although transformer-based language models are described herein, it should be understood that the present disclosure may be applicable to any machine learning (ML)-based language model, including language models based on other neural network architectures such as recurrent neural network (RNN)-based language models.

The transformer 112 includes an encoder 108 (which can comprise one or more encoder layers/blocks connected in series) and a decoder 110 (which can comprise one or more decoder layers/blocks connected in series). Generally, the encoder 108 and the decoder 110 each include a plurality of neural network layers, at least one of which can be a self-attention layer. The parameters of the neural network layers can be referred to as the parameters of the language model.

The transformer 112 can be trained to perform certain functions on a natural language input. For example, the functions include summarizing existing content, brainstorming ideas, writing a rough draft, fixing spelling and grammar, and translating content. Summarizing can include extracting key points from an existing content in a high-level summary. Brainstorming ideas can include generating a list of ideas based on provided input. For example, the ML model can generate a list of names for a startup or costumes for an upcoming party. Writing a rough draft can include generating writing in a particular style that could be useful as a starting point for the user's writing. The style can be identified as, e.g., an email, a blog post, a social media post, or a poem. Fixing spelling and grammar can include correcting errors in an existing input text. Translating can include converting an existing input text into a variety of different languages. In some implementations, the transformer 112 is trained to perform certain functions on other input formats than natural language input. For example, the input can include objects, images, audio content, or video content, or a combination thereof.

The transformer 112 can be trained on a text corpus that is labeled (e.g., annotated to indicate verbs, nouns, and so forth) or unlabeled. Large language models (LLMs) can be trained on a large unlabeled corpus. The term “language model,” as used herein, can include an ML-based language model (e.g., a language model that is implemented using a neural network or other ML architecture), unless stated otherwise. Some LLMs can be trained on a large multi-language, multi-domain corpus to enable the model to be versatile at a variety of language-based tasks such as generative tasks (e.g., generating human-like natural language responses to natural language input). FIG. 1 illustrates an example of how the transformer 112 can process textual input data. Input to a language model (whether transformer-based or otherwise) typically is in the form of natural language that can be parsed into tokens. It should be appreciated that the term “token” in the context of language models and Natural Language Processing (NLP) has a different meaning from the use of the same term in other contexts such as data security. Tokenization, in the context of language models and NLP, refers to the process of parsing textual input (e.g., a character, a word, a phrase, a sentence, a paragraph) into a sequence of shorter segments that are converted to numerical representations referred to as tokens (or “compute tokens”). Typically, a token can be an integer that corresponds to the index of a text segment (e.g., a word) in a vocabulary dataset. Often, the vocabulary dataset is arranged by frequency of use. Commonly occurring text, such as punctuation, can have a lower vocabulary index in the dataset and thus be represented by a token having a smaller integer value than more commonly occurring text. Tokens frequently correspond to words, with or without white space appended. In some examples, a token can correspond to a portion of a word.

For example, the word “greater” can be represented by a token for [great] and a second token for [er]. In another example, the text sequence “write a summary” can be parsed into the segments [write], [a], and [summary], each of which can be represented by a respective numerical token. In addition to tokens that are parsed from the textual sequence (e.g., tokens that correspond to words and punctuation), there can also be special tokens to encode non-textual information. For example, a [CLASS] token can be a special token that corresponds to a classification of the textual sequence (e.g., can classify the textual sequence as a list, a paragraph, and so forth), an [EOT] token can be another special token that indicates the end of the textual sequence, other tokens can provide formatting information, etc.

In FIG. 1, a short sequence of tokens 102 corresponding to the input text is illustrated as input to the transformer 112. Tokenization of the text sequence into the tokens 102 can be performed by some pre-processing tokenization module such as, for example, a byte-pair encoding tokenizer (the “pre” referring to the tokenization occurring prior to the processing of the tokenized input by the LLM), which is not shown in FIG. 1 for simplicity. In general, the token sequence that is inputted to the transformer 112 can be of any length up to a maximum length defined based on the dimensions of the transformer 112. Each token 102 in the token sequence is converted into an embedding vector 106 (also referred to simply as an embedding 106). An embedding 106 is a learned numerical representation (such as, for example, a vector) of a token that captures some semantic meaning of the text segment represented by the token 102. The embedding 106 represents the text segment corresponding to the token 102 in a way such that embeddings corresponding to semantically related text are closer to each other in a vector space than embeddings corresponding to semantically unrelated text. For example, assuming that the words “write,” “a,” and “summary” each correspond to, respectively, a “write” token, an “a” token, and a “summary” token when tokenized, the embedding 106 corresponding to the “write” token will be closer to another embedding corresponding to the “jot down” token in the vector space as compared to the distance between the embedding 106 corresponding to the “write” token and another embedding corresponding to the “summary” token.

The vector space can be defined by the dimensions and values of the embedding vectors. Various techniques can be used to convert a token 102 to an embedding 106. For example, another trained ML model can be used to convert the token 102 into an embedding 106. In particular, another trained ML model can be used to convert the token 102 into an embedding 106 in a way that encodes additional information into the embedding 106 (e.g., a trained ML model can encode positional information about the position of the token 102 in the text sequence into the embedding 106). In some examples, the numerical value of the token 102 can be used to look up the corresponding embedding in an embedding matrix 104 (which can be learned during training of the transformer 112).

The generated embeddings 106 are input into the encoder 108. The encoder 108 serves to encode the embeddings 106 into feature vectors 114 that represent the latent features of the embeddings 106. The encoder 108 can encode positional information (i.e., information about the sequence of the input) in the feature vectors 114. The feature vectors 114 can have very high dimensionality (e.g., on the order of thousands or tens of thousands), with each element in a feature vector 114 corresponding to a respective feature. The numerical weight of each element in a feature vector 114 represents the importance of the corresponding feature. The space of all possible feature vectors 114 that can be generated by the encoder 108 can be referred to as the latent space or feature space.

Conceptually, the decoder 110 is designed to map the features represented by the feature vectors 114 into meaningful output, which can depend on the task that was assigned to the transformer 112. For example, if the transformer 112 is used for a translation task, the decoder 110 can map the feature vectors 114 into text output in a target language different from the language of the original tokens 102. Generally, in a generative language model, the decoder 110 serves to decode the feature vectors 114 into a sequence of tokens. The decoder 110 can generate output tokens 116 one by one. Each output token 116 can be fed back as input to the decoder 110 in order to generate the next output token 116. By feeding back the generated output and applying self-attention, the decoder 110 is able to generate a sequence of output tokens 116 that has sequential meaning (e.g., the resulting output text sequence is understandable as a sentence or other structure and obeys grammatical rules). The decoder 110 can generate output tokens 116 until a special [EOT] token (indicating the end of the text) is generated. The resulting sequence of output tokens 116 can then be converted to a text sequence in post-processing. For example, each output token 116 can be an integer number that corresponds to a vocabulary index. By looking up the text segment using the vocabulary index, the text segment corresponding to each output token 116 can be retrieved, the text segments can be concatenated together, and the final output text sequence can be obtained.

In some examples, the input provided to the transformer 112 includes instructions to perform a function on an existing text. The output can include, for example, a modified version of the input text based on instructions to modify the text. The modification can include summarizing, translating, correcting grammar or spelling, changing the style of the input text, lengthening or shortening the text, or changing the format of the text. For example, the input can include the question “What is the weather like in Australia?” and the output can include a description of the weather in Australia.

Although a general transformer architecture for a language model and its theory of operation have been described above, this is not intended to be limiting. Existing language models include language models that are based only on the encoder of the transformer or only on the decoder of the transformer. An encoder-only language model encodes the input text sequence into feature vectors that can then be further processed by a task-specific layer (e.g., a classification layer). BERT is an example of a language model that can be considered to be an encoder-only language model. A decoder-only language model accepts embeddings as input and can use auto-regression to generate an output text sequence. Transformer-XL and GPT-type models can be language models that are considered to be decoder-only language models.

Because GPT-type language models tend to have a large number of parameters, these language models can be considered LLMs. An example of a GPT-type LLM is GPT-3. GPT-3 is a type of GPT language model that has been trained (in an unsupervised manner) on a large corpus derived from documents available to the public online. GPT-3 has a very large number of learned parameters (on the order of hundreds of billions), is able to accept a large number of tokens as input (e.g., up to 2,048 input tokens), and is able to generate a large number of tokens as output (e.g., up to 2,048 tokens). GPT-3 has been trained as a generative model, meaning that it can process input text sequences to predictively generate a meaningful output text sequence. ChatGPT is built on top of a GPT-type LLM and has been fine-tuned with training datasets based on text-based chats (e.g., chatbot conversations). ChatGPT is designed for processing natural language, receiving chat-like inputs, and generating chat-like outputs.

A computer system can access a remote language model (e.g., a cloud-based language model), such as ChatGPT or GPT-3, via a software interface (e.g., an application programming interface (API)). Additionally or alternatively, such a remote language model can be accessed via a network such as, for example, the Internet. In some implementations, for example in the case of a cloud-based language model, a remote language model can be hosted by a computer system that can include a plurality of cooperating (e.g., cooperating via a network) computer systems that can be in, for example, a distributed arrangement. Notably, a remote language model can employ a plurality of processors (e.g., hardware processors such as processors of cooperating computer systems). Indeed, processing of inputs by an LLM can be computationally expensive. For example, processing inputs by an LLM can involve a large number of operations and/or consume a large amount of memory (e.g., many instructions can be executed, large data structures can be accessed from memory, and so forth), and providing output in a required timeframe (e.g., real time, near real time, within a few seconds, etc.) can require the use of a plurality of processors/cooperating computing devices as discussed above.

Inputs to an LLM can be referred to as a prompt, which is a natural language input that includes instructions to the LLM to generate a desired output. A computer system can generate a prompt that is provided as input to the LLM via its API. As described above, the prompt can optionally be processed or pre-processed into a token sequence prior to being provided as input to the LLM via its API. A prompt can include one or more examples of the desired output, which provides the LLM with additional information to enable the LLM to generate output according to the desired output. Additionally or alternatively, the examples included in a prompt can include inputs and corresponding outputs. For example, the examples can provide inputs (e.g., example inputs) corresponding to and/or that can be expected to result in the desired outputs provided. A one-shot prompt refers to a prompt that includes one example, and a few-shot prompt refers to a prompt that includes multiple examples. A prompt that includes no examples can be referred to as a zero-shot prompt.

### Enhanced Customer Support

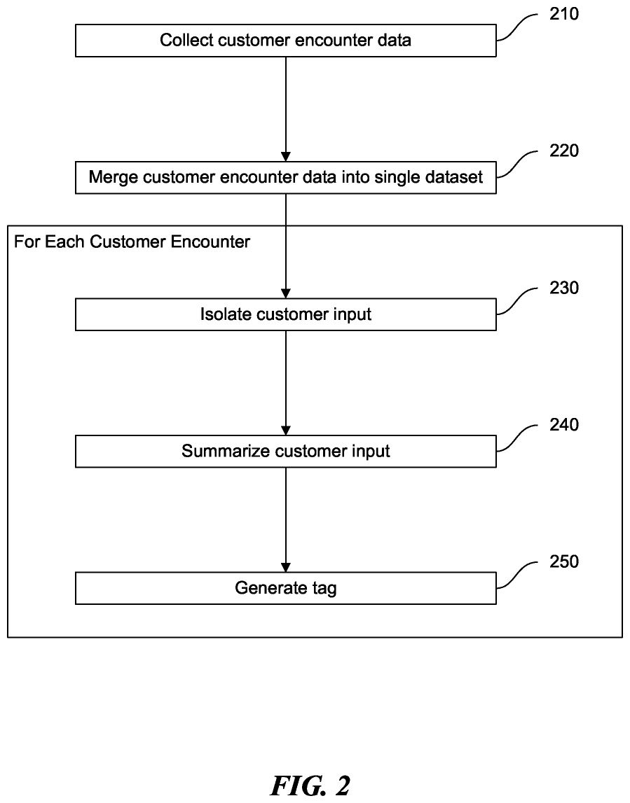

FIG. 2 is a flowchart of an example method for summarizing customer encounter data according to some implementations. The process 200 can be carried out on a computing system.

At operation 210, the computing system can collect customer encounter data. The customer encounter data can be data from one or more channels. For example, the customer encounter data can be, for example, call recording transcripts, in-store customer service summaries, text-based support transcripts, or any combination thereof, or any other customer support interaction data. The customer encounter data can be stored in one or more databases. At operation 220, the computing system can merge the customer encounter data into a single dataset. The merging can include, for example, adding or dropping certain fields, normalizing formats (e.g., ensuring that dates are in a standardized format), and so forth. At operation 230, the computing system can isolate customer input. In some cases, (e.g., text-based input), the customer input can be easily separated from input from a customer support agent. In other cases, such as video or audio recordings, the input data can be analyzed (for example using an ML classification model) to determine which pieces of the input data correspond to the customer. At operation 240, the computing system can summarize the customer input. For example, in some cases, the customer input can be provided to an LLM, and a prompt can be provided to the LLM to request a summary of the customer input. In some cases, the prompt can specify a length of the summary. At operation 250, the computing system can generate a call tag. The call tag can be, for example, a single word or a few words that identify a type of issue for the customer encounter (e.g., “dropped calls,” “high bill,” “slow network,” etc.) from among a set of finite known issues.

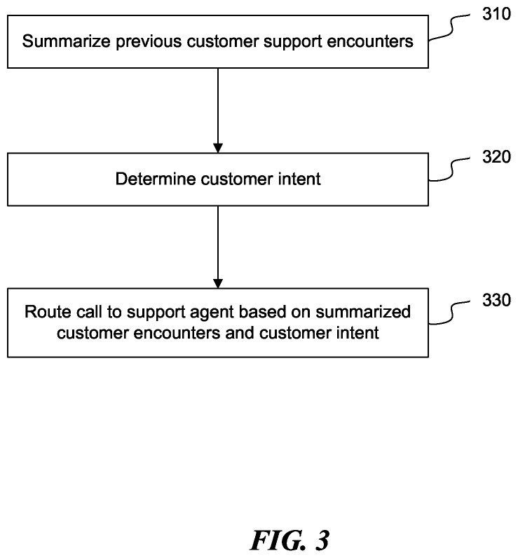

FIG. 3 is a flowchart of an example method for routing a customer support interaction based on customer intent. The process of FIG. 3 can be carried out on a computing system. At operation 310, the computing system can summarize previous customer support encounters. In some implementations, the previous customer support counters can include issues known issues that customers have faced in the past and/or new, unknown issues. In some implementations, the summarizing can occur when a customer contacts support. In some implementations, the summarizing can occur before a customer contacts support. Performing the summarizing when a customer contacts support can save computational resources as summarizing operations can, in some implementations, be performed only for support interactions corresponding to customers who subsequently contact customer support. However, such an approach can have a drawback in that producing summaries can take some time, which can result in a delay in determining customer intent. Summarizing customer support encounters before a customer calls or otherwise initiates a support encounter can result in more rapid customer intent determination, but computational resources can be wasted processing customer support interactions related to customers who do not contact customer support again. However, such summaries can still be useful, for example for training machine learning models. In some implementations, the summarizing can be performed based on the totality of a support encounter. For example, the call summary can be based on both what the customer said (e.g., via voice or text) and what the support agent said (e.g., via voice or text). In some implementations, summaries can be based on only inputs from the customer or only inputs from the support agent.

At operation 320, the computing system can, based on the summarized previous interactions, determine the customer intent. As discussed herein, while previous customer support encounters can be used to determine customer intent, in some cases customer intent can be based on, for example, known network issues, known events disrupting service, and so forth. At operation 330, the computing system can route the call to a custom support agent based on the summarized custom interactions, the determined customer intent, or both. In some implementations, additionally or alternatively, customer intent can be determined based on known network issues, known service interruptions, known events in the customer's location, and so forth. In some implementations, customer intent can be determined based on a customer intent indication provided by the customer, such as a selection in a chatbot, selection in a phone menu, etc.

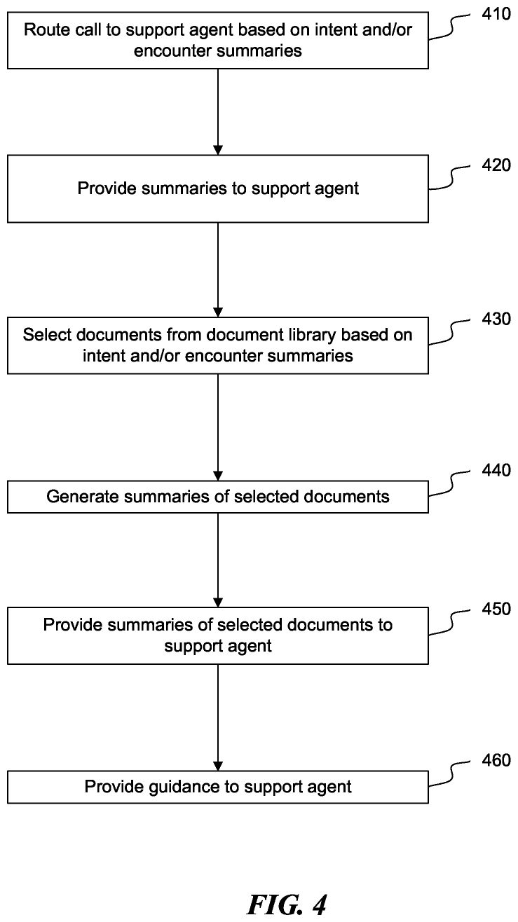

FIG. 4 is a flowchart of an example method for optimizing a customer support interaction according to some implementations. At operation 410, a computing system can route a customer support interaction (e.g., a call, chat, etc.) to a customer support agent and/or to a self-service resource (e.g., an FAQ, webpage, etc.) based on a determined customer intent. In some cases, the determined customer intent can be based on summaries of previous customer support encounters, for example as described above with respect to FIG. 3. In some implementations, additionally or alternatively, customer intent can be determined based on known network issues, known service interruptions, known events in the customer's location, and so forth.

At operation 410, a computing system can route a call to a support representative based on intent and/or interaction summaries. At operation 420, the computing system can provide summaries of previous customer support encounters to the customer support agent. Summaries can be generated as described herein, for example using a large language model. At operation 430, the computing system can select documents from a document library based on the intent and/or summaries of previous encounters. In some implementations, as described herein, the computing system can use other or additional information in selecting documents. For example, documents that are inapplicable to the customer's hardware, software, and/or services can be excluded from selection.

At operation 440, the computing system can generate summaries of the one or more selected documents. For example, the computing system can provide the one or more selected documents to an LLM, and a prompt can be input to the LLM requesting a summary of each of the one or more selected documents. At operation 450, the computing system can provide the summaries of the one or more selected documents to the support agent. For example, the summaries and/or links to the summaries can be displayed on a display of a computer system used by the support agent.

At operation 460, the computing system can provide guidance to the support agent. For example, the computing system can indicate a first one of the one or more selected documents to use for initial troubleshooting steps, can provide an indication of which documents are most likely to help in resolving or mitigating the customer's issue, can provide an indication of which documents have already been used during previous support encounters, and so forth.

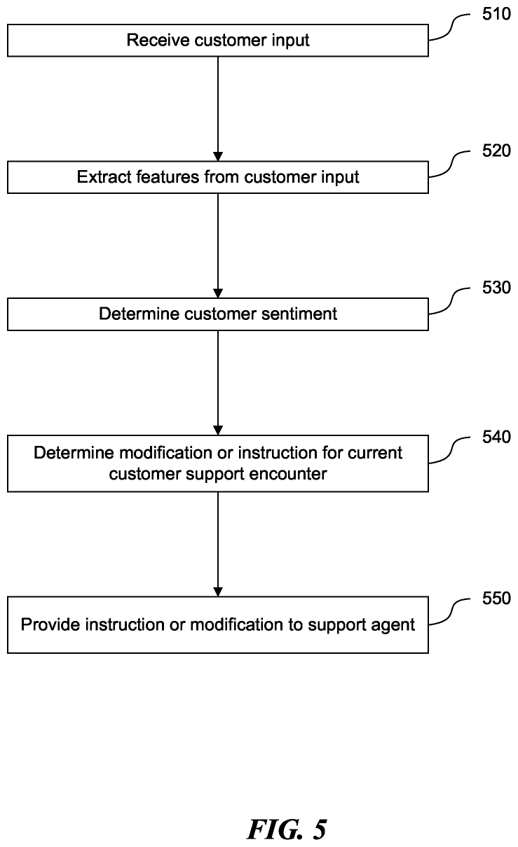

FIG. 5 is a flowchart of an example method for determining and reacting to customer sentiment according to some implementations. At operation 510, a computing system can receive a customer input. The customer input can be, for example, audio (e.g., a recording of the customer's speech), text (e.g., text typed by the customer in an email, chat session, etc.), video (e.g., video captured during a video chat session and/or during an in-store interaction). At operation 520, the computing system can extract features from the customer input. And can provide the extracted features to one or more machine learning models as described herein. At operation 530, the computing system can, using the one or more machine learning models, determine the customer's sentiment. For example, as described herein, sentiment can be determined based on one or more of words spoken or written by the customer, vocal qualities of the user (e.g., speed, pitch, tone, volume, etc.), and/or physical expressions of the customer (e.g., frowning, smiling, waving hands, shrugging shoulders, etc.).

At operation 540, the computing system can determine a modification and/or instruction for the current customer support encounter. For example, the computing system can determine that the support agent should attempt to calm the customer, reassure the customer, take a friendlier tone with the customer, take a more direct tone with the customer (e.g., if the customer appears agitated that a troubleshooting process is taking too long, the computing system can determine that the support agent should reduce explanations, work through troubleshooting steps more quickly, etc.), etc. In some implementations, the computing system may remind the support agent to maintain a professional tone. For example, if a customer is agitated and begins yelling or otherwise behaving negatively toward the support agent, the computing system can determine that the support agent should be reminded to remain calm and professional. In some cases, the computing system can determine that the support agent should be provided with instructions for de-escalating or ending the customer support encounter. At operation 550, the computing system can provide the modification and/or instruction to the support agent.

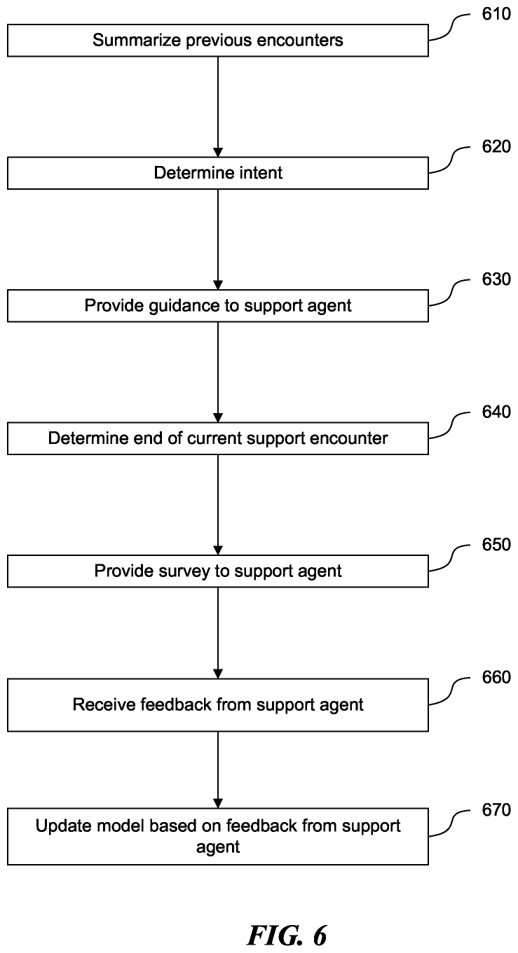

FIG. 6 is a flowchart of an example method for providing guidance to a support agent during a support encounter and updating one or more machine learning models based on feedback from the support agent according to some implementations. At operation 610, a computing system can summarize previous interactions as described herein. At operation 620, the computing system can determine a customer intent as described herein. At operation 630, the computing system can provide guidance to the support agent as described herein. For example, the computing system can provide summaries of past support encounters, summaries of support documents, indications of support documents to focus on (e.g., in the case of repeat customer support encounters, the computing system can recommend that the support agent start with support documents that have not previously been used to address the customer's issue). At operation 640, the computing system can determine that the current support encounter has ended. For example, the computing system can determine that the current support encounter has ended when the customer hangs up, the support agent hangs up, the customer ends a chat session, the support agent ends a chat session, the customer doesn't respond to a support email for more than a threshold period of time, the support agent marks the customer support encounter as completed, and/or the customer support encounter is otherwise terminated.

At operation 650, the computing system can provide a post-support survey to the support agent. The post-support survey can include one or more questions. For example, the post-support survey can ask the support agent to rate the effectiveness of prior support encounter summaries, the effectiveness of support document summaries, and/or the effectiveness of guidance provided to the support agent to respond to the customer's sentiment. At operation 660, the computing system can receive feedback from the support agent. At operation 670, the received feedback can be used to update one or more machine learning models. In the context of supervised learning, the feedback can be used to label data that is input into the one or more machine learning models. In some implementations, the one or more machine learning models can be updated continuously, for example each time feedback is received. In some implementations, the one or more machine learning models can be updated periodically, for example daily, weekly, monthly, yearly, or at any other frequency. In some implementations, the one or more machine learning models can be updated when a telecommunications company determines that the one or more machine learning models are not performing as expected, for example are not meeting minimum key performance indicators (KPIs) for effectiveness.

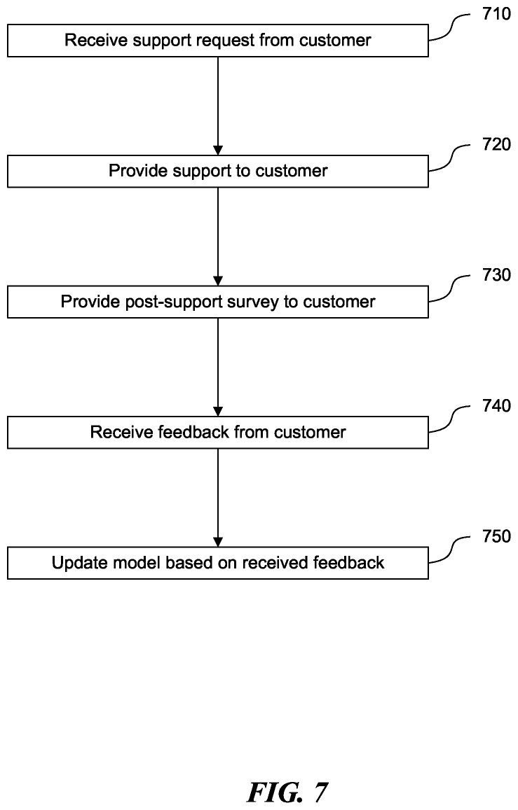

FIG. 7 is a flowchart of an example method for receiving post-support feedback from a customer and updated one or more machine learning models according to some implementations. At operation 710, a telecommunications service can receive a support request from a customer. A computing system can receive the request from the customer. At operation 720, a support agent of the telecommunications service can provide support to the customer. The computing system can provide summaries of previous support encounters, summaries of support documents, and/or other guidance to the support agent during the support encounter, for example as described herein. At operation 730, the computing system can provide a post-support survey to the customer after the support encounter ends, for example via text message, email, a phone survey after the completion of the support encounter, etc. At operation 740, the computing system can receive feedback from the customer. For example, the customer can rate the effectiveness of support, the performance of the support agent, etc. For example, if the customer rates the effectiveness highly, this can indicate that the summaries of previous support encounters and/or the summaries of one or more support documents was effective. If the customer rates the effectiveness poorly, this can indicate that the summaries of previous support encounters and/or the summaries of one or more support documents was ineffective. If the customer rates the performance of the support agent highly, this can indicate that the guidance provided to the support agent was effective. If the customer rates the performance of the support agent poorly, this can indicate that the guidance provided to the support agent was not effective.

At operation 750, the computing system can update one or more machine learning models based on the received feedback. For example, the customer feedback can be used to label data used in supervised learning. The updating can be carried out in a manner similar to or the same as that described with respect to FIG. 6.

When relying on customer feedback, it can be important to consider that responses can be biased (e.g., the likelihood of receiving a response can depend on whether or not the customer was satisfied with the support they received), responses to different questions may not be answered independently (e.g., even if a customer's issue was resolved quickly and completely, the customer may rate the effectiveness poorly if they had a negative experience with the support agent), responses may not clearly indicate which of one or more machine learning models may need to be retrained, and/or responses may not be reflective of the performance of one or more machine learning models used in providing support. For example, summaries may have been of high quality, but the support agent may not have read them. Similarly, guidance provided to the support agent during the support encounter may have been disregarded by the support agent. Thus, while customer feedback can be important, in some implementations, customer feedback can have a limited role in updating the one or more machine learning models. In some implementations, techniques such as random oversampling, random undersampling, SMOTE, Near-Miss, and/or other data balancing techniques can be used to account for bias-related issues associated with customer feedback.

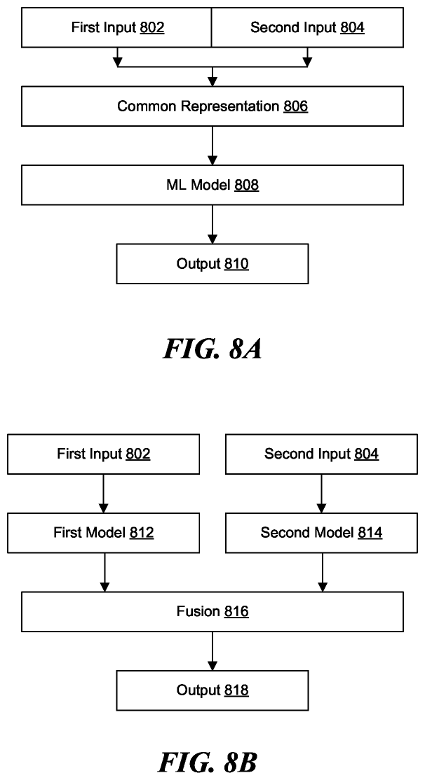

FIGS. 8A and 8B illustrate example approaches to multi-modal machine learning according to some implementations. The approaches shown in FIGS. 8A and 8B can be used for sentiment analysis. Various approaches can be used in multi-modal machine learning. For example, fusion can be categorized as early, intermediate, or late. In early fusion, inputs can be combined prior to feature extraction. In intermediate fusion, features can be combined after extraction, for example via concatenation. In late fusion, the outputs of multiple machine learning models can be combined to provide a final output.

FIG. 8A illustrates an example approach to multi-modal machine learning that uses early or intermediate fusion. A first input 802 and a second input 804 can be combined to form a common representation 806. The combining can occur before or after feature extraction. The common representation 806 can be provided to a machine learning model 808, which can provide an output 810.

FIG. 8B illustrates an example approach to multi-modal machine learning that uses late fusion. A first input 802 can be provided to a first machine learning model 812. A second input 804 can be provided to a second machine learning model 814. The output of the first machine learning model 812 and the output the second machine learning model 814 can be provided to a fusion module 816. The fusion module 816 can combine the outputs of the first machine learning model 812 and the output of the second machine learning model 814 to produce a final output 818 using various means, for example via averaging the outputs, via a voting mechanism (e.g., a model with a higher confidence in the output can determine the final output or, when more than two models are used, an output agreed upon by a majority or plurality of machine learning models can be used to determine the final output).

In the context of sentiment analysis, the first input 802 and second input 804 can be, for example, audio of a customer, video of a customer, and or words spoken by a customer. While two inputs are shown in FIGS. 8A and 8B, it will be appreciated that more inputs can be present, as can more machine learning models in the example of FIG. 8B.

### Computer System

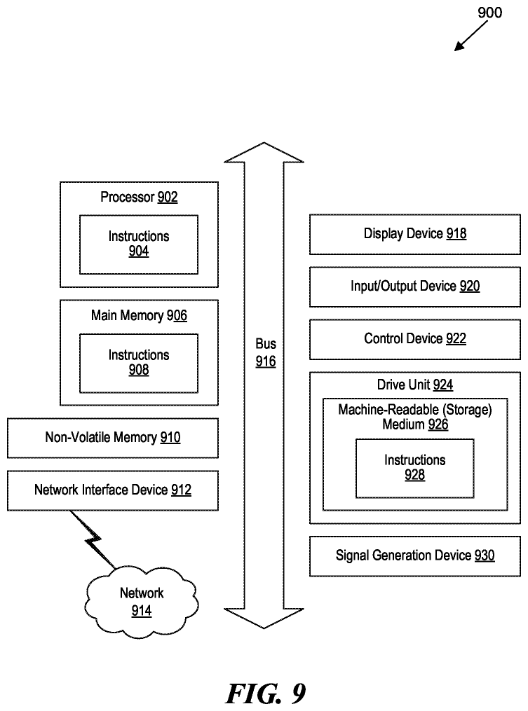

FIG. 9 is a block diagram that illustrates an example of a computer system 900 in which at least some operations described herein can be implemented. As shown, the computer system 900 can include: one or more processors 902, main memory 906, non-volatile memory 910, a network interface device 912, a video display device 918, an input/output device 920, a control device 922 (e.g., keyboard and pointing device), a drive unit 924 that includes a machine-readable (storage) medium 926, and a signal generation device 930 that are communicatively connected to a bus 916. The bus 916 represents one or more physical buses and/or point-to-point connections that are connected by appropriate bridges, adapters, or controllers. Various common components (e.g., cache memory) are omitted from FIG. 9 for brevity. Instead, the computer system 900 is intended to illustrate a hardware device on which components illustrated or described relative to the examples of the figures and any other components described in this specification can be implemented.

The computer system 900 can take any suitable physical form. For example, the computing system 900 can share a similar architecture as that of a server computer, personal computer (PC), tablet computer, mobile telephone, game console, music player, wearable electronic device, network-connected (“smart”) device (e.g., a television or home assistant device), AR/VR systems (e.g., head-mounted display), or any electronic device capable of executing a set of instructions that specify action(s) to be taken by the computing system 900. In some implementations, the computer system 900 can be an embedded computer system, a system-on-chip (SOC), a single-board computer system (SBC), or a distributed system such as a mesh of computer systems, or it can include one or more cloud components in one or more networks. Where appropriate, one or more computer systems 900 can perform operations in real time, in near real time, or in batch mode.

The network interface device 912 enables the computing system 900 to mediate data in a network 914 with an entity that is external to the computing system 900 through any communication protocol supported by the computing system 900 and the external entity. Examples of the network interface device 912 include a network adapter card, a wireless network interface card, a router, an access point, a wireless router, a switch, a multilayer switch, a protocol converter, a gateway, a bridge, a bridge router, a hub, a digital media receiver, and/or a repeater, as well as all wireless elements noted herein.

The memory (e.g., main memory 906, non-volatile memory 910, machine-readable medium 926) can be local, remote, or distributed. Although shown as a single medium, the machine-readable medium 926 can include multiple media (e.g., a centralized/distributed database and/or associated caches and servers) that store one or more sets of instructions 928. The machine-readable medium 926 can include any medium that is capable of storing, encoding, or carrying a set of instructions for execution by the computing system 900. The machine-readable medium 926 can be non-transitory or comprise a non-transitory device. In this context, a non-transitory storage medium can include a device that is tangible, meaning that the device has a concrete physical form, although the device can change its physical state. Thus, for example, non-transitory refers to a device remaining tangible despite this change in state.

Although implementations have been described in the context of fully functioning computing devices, the various examples are capable of being distributed as a program product in a variety of forms. Examples of machine-readable storage media, machine-readable media, or computer-readable media include recordable-type media such as volatile and non-volatile memory 910, removable flash memory, hard disk drives, optical disks, and transmission-type media such as digital and analog communication links.

In general, the routines executed to implement examples herein can be implemented as part of an operating system or a specific application, component, program, object, module, or sequence of instructions (collectively referred to as “computer programs”). The computer programs typically comprise one or more instructions (e.g., instructions 904, 908, 928) set at various times in various memory and storage devices in computing device(s). When read and executed by the processor 902, the instruction(s) cause the computing system 900 to perform operations to execute elements involving the various aspects of the disclosure.

### Remarks

The terms “example,” “embodiment,” and “implementation” are used interchangeably. For example, references to “one example” or “an example” in the disclosure can be, but not necessarily are, references to the same implementation; and such references mean at least one of the implementations. The appearances of the phrase “in one example” are not necessarily all referring to the same example, nor are separate or alternative examples mutually exclusive of other examples. A feature, structure, or characteristic described in connection with an example can be included in another example of the disclosure. Moreover, various features are described that can be exhibited by some examples and not by others. Similarly, various requirements are described that can be requirements for some examples but not for other examples.

The terminology used herein should be interpreted in its broadest reasonable manner, even though it is being used in conjunction with certain specific examples of the invention. The terms used in the disclosure generally have their ordinary meanings in the relevant technical art, within the context of the disclosure, and in the specific context where each term is used. A recital of alternative language or synonyms does not exclude the use of other synonyms. Special significance should not be placed upon whether or not a term is elaborated or discussed herein. The use of highlighting has no influence on the scope and meaning of a term. Further, it will be appreciated that the same thing can be said in more than one way.

Unless the context clearly requires otherwise, throughout the description and the claims, the words “comprise,” “comprising,” and the like are to be construed in an inclusive sense, as opposed to an exclusive or exhaustive sense—that is to say, in the sense of “including, but not limited to.” As used herein, the terms “connected,” “coupled,” and any variants thereof mean any connection or coupling, either direct or indirect, between two or more elements; the coupling or connection between the elements can be physical, logical, or a combination thereof. Additionally, the words “herein,” “above,” “below,” and words of similar import can refer to this application as a whole and not to any particular portions of this application. Where context permits, words in the above Detailed Description using the singular or plural number may also include the plural or singular number, respectively. The word “or” in reference to a list of two or more items covers all of the following interpretations of the word: any of the items in the list, all of the items in the list, and any combination of the items in the list. The term “module” refers broadly to software components, firmware components, and/or hardware components.

While specific examples of technology are described above for illustrative purposes, various equivalent modifications are possible within the scope of the invention, as those skilled in the relevant art will recognize. For example, while processes or blocks are presented in a given order, alternative implementations can perform routines having steps, or employ systems having blocks, in a different order, and some processes or blocks may be deleted, moved, added, subdivided, combined, and/or modified to provide alternative or sub-combinations. Each of these processes or blocks can be implemented in a variety of different ways. Also, while processes or blocks are at times shown as being performed in series, these processes or blocks can instead be performed or implemented in parallel or can be performed at different times. Further, any specific numbers noted herein are only examples such that alternative implementations can employ differing values or ranges.

Details of the disclosed implementations can vary considerably in specific implementations while still being encompassed by the disclosed teachings. As noted above, particular terminology used when describing features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed herein, unless the above Detailed Description explicitly defines such terms. Accordingly, the actual scope of the invention encompasses not only the disclosed examples but also all equivalent ways of practicing or implementing the invention under the claims. Some alternative implementations can include additional elements to those implementations described above or include fewer elements.

Any patents and applications and other references noted above, and any that may be listed in accompanying filing papers, are incorporated herein by reference in their entireties, except for any subject matter disclaimers or disavowals, and except to the extent that the incorporated material is inconsistent with the express disclosure herein, in which case the language in this disclosure controls. Aspects of the invention can be modified to employ the systems, functions, and concepts of the various references described above to provide yet further implementations of the invention.

To reduce the number of claims, certain implementations are presented below in certain claim forms, but the applicant contemplates various aspects of an invention in other forms. For example, aspects of a claim can be recited in a means-plus-function form or in other forms, such as being embodied in a computer-readable medium. A claim intended to be interpreted as a means-plus-function claim will use the words “means for.” However, the use of the term “for” in any other context is not intended to invoke a similar interpretation. The applicant reserves the right to pursue such additional claim forms either in this application or in a continuing application.

What is claimed is:

1. A method for issue mitigation for a customer of a telecommunications service comprising:
receiving, from the customer, a request for a support encounter;
determining an intent of the customer, the intent indicative of an issue experienced by the customer, wherein the intent is determined using data related to the request for the support encounter;
routing the customer to a support agent based on the determined intent;
generating, using a first large language model, one or more summaries of one or more previous support encounters involving the customer, wherein an input to the first large model comprises information related to the one or more previous support encounters;
providing, to the support agent, the one or more summaries of the one or more previous support encounters;
determining, based on at least one of the determined intent or the one or more generated summaries of one or more previous encounters, one or more support documents related to the issue experienced by the customer;
generating, using a second large language model, a summary of each of the one or more support documents, wherein an input to the second large language model comprises a support document of the one or more support documents; and
providing the generated one or more summaries of the one or more support documents to the support agent for use by the support agent to mitigate the issue experienced by the customer.

2. The method of claim 1, wherein generating the one or more summaries of the one or more previous support encounters is performed before determining the intent of the customer, wherein the intent of the customer is determined based on the one or more summaries of the one or more previous support encounters.

3. The method of claim 1, wherein the one or more previous support encounters occurred within a threshold period of time of the requested support encounter.

4. The method of claim 1, wherein the generated one or more summaries of the one or more support documents comprise one or more troubleshooting steps contained in the one or more support documents.

5. The method of claim 1, wherein the one or more previous support encounters comprise support encounters across a plurality of channels comprising two or more of telephone support, chat support, email support, or in-person support.

6. The method of claim 5, wherein generating the one or more summaries of the one or more previous support encounters comprises:
retrieving, from a plurality of data sources, previous support encounter data;
converting the previous support encounter data to a standardized format; and
generating a merged dataset comprising the converted previous support encounter data.

7. The method of claim 1, wherein the data related to the request for the support encounters comprises one or more of: public information, internal information, or an intent indicated by the customer,
wherein the public information comprises information related to at least one of a weather event, an emergency, a gathering, a software update, or a hardware release,
wherein the internal information comprises information related to at least one of a service interruption of the telecommunications service or a customer bill.

8. The method of claim 1, further comprising:
receiving, during the support encounter, a customer input;
determining, based on the customer input, a sentiment of the customer, wherein the intent is determined by applying a sentiment model to the customer input;
determining, using on the sentiment, an action to be performed by the support agent; and
providing, to the support agent, one or more instructions to perform the action.

9. The method of claim 8, wherein the customer input comprises audio input, and wherein determining the sentiment comprises:
isolating a speech of the customer from a speech of the support agent;
generating a text representation of the isolated speech; and
inputting the generated text representation to a text-based sentiment analysis model to determine the sentiment.

10. The method of claim 8, wherein the customer input comprises audio input, and wherein determining the sentiment comprises:
isolating a speech of the customer from a speech of the support agent;
extracting one or more features from the isolated speech of the customer, the one or more features related to at least one of: a pitch, an amplitude, a tone of voice, a speed, or a Mel Frequency Cepstral Coefficient (MFCC) of the speech of the customer; and
inputting the one or more extracted features to an audio-based sentiment analysis model to determine the sentiment.

11. The method of claim 8, wherein the customer input comprises audio input, and wherein determining the sentiment comprises:
isolating a speech of the customer from a speech of the support agent;
generating a text representation of the isolated speech;
providing the generated text representation to a first sentiment analysis model to produce a first output; generating a numerical representation of the isolated speech, the numerical representation corresponding to at least one of a tone, a speed, an amplitude, a pitch, or a Mel Frequency Cepstral Coefficient (MFCC);
providing the numerical representation to a second sentiment analysis model to produce a second output; and
determining, based on the first output and the second output, the sentiment.

12. The method of claim 1, further comprising:
providing, to the support agent, a post-support survey, the post-support survey configured to obtain information about an effectiveness of the generated one or more summaries of the one or more previous support encounters;
receiving, from the support agent, a response to the post-support survey; and
updating the first large language model based on the post-support survey, wherein the updating comprises adjusting one or more weights of the first large language model.

13. The method of claim 1, further comprising:
providing, to the customer, a post-support survey, the post-support survey configured to obtain information about an effectiveness of the generated one or more summaries of the one or more previous support encounters;
receiving, from the customer, a response to the post-support survey; and
updating the first large language model based on the post-support survey, wherein the updating comprises adjusting one or more weights of the first large language model.

14. A system for mitigating issues for a customer of a telecommunications service, the system comprising:
a processor; and
a non-volatile computer-readable storage medium having instructions recorded thereon that, when executed by the processor, cause the system to:
receive, from the customer, a request for a support encounter;
determine an intent of the customer, the intent indicative of an issue experienced by the customer, wherein the intent is determined using data related to the request for the support encounter;
route the customer to a support agent based on the determined intent;
generate, using a first large language model, one or more summaries of one or more previous support encounters involving the customer, wherein an input to the first large model comprises information related to the one or more previous support encounters;
provide, to the support agent, the one or more summaries of the one or more previous support encounters;
determine, based on at least one of the determined intent or the one or more generated summaries of one or more previous encounters, one or more support documents related to the issue experienced by the customer;
generate, using a second large language model, a summary of each of the one or more support documents, wherein an input to the second large language model comprises a support document of the one or more support documents; and
provide the generated one or more summaries of the one or more support documents to the support agent for use by the support agent to mitigate the issue experienced by the customer.

15. The system of claim 14, wherein generating the one or more summaries of the one or more previous support encounters is performed before determining the intent of the customer, wherein the intent of the customer is determined based on the one or more summaries of the one or more previous support encounters.

16. The system of claim 14, wherein the instructions, when executed by the processor, further cause the system to:
provide, to the support agent, a post-support survey, the post-support survey configured to obtain information about an effectiveness of the generated one or more summaries of the one or more previous support encounters;
receive, from the support agent, a response to the post-support survey; and
update the first large language model based on the post-support survey, wherein the updating comprises adjusting one or more weights of the first large language model.

17. The system of claim 14, wherein the data related to the request for the support encounters comprises one or more of: public information, internal information, or an intent indicated by the customer,
wherein the public information comprises information related to at least one of a weather event, an emergency, a gathering, a software update, or a hardware release,
wherein the internal information comprises information related to at least one of a service interruption of the telecommunications service or a customer bill.

18. A non-transitory, computer-readable storage medium comprising instructions recorded thereon, wherein the instructions when executed by at least one data processor of a system, cause the system to:
receive, from a customer of a telecommunications service, a request for a support encounter;
determine an intent of the customer, the intent indicative of an issue experienced by the customer, wherein the intent is determined using data related to the request for the support encounter;
route the customer to a support agent based on the determined intent;
generate, using a first large language model, one or more summaries of one or more previous support encounters involving the customer, wherein an input to the first large model comprises information related to the one or more previous support encounters;
provide, to the support agent, the one or more summaries of the one or more previous support encounters;
determine, based on at least one of the determined intent or the one or more generated summaries of one or more previous encounters, one or more support documents related to the issue experienced by the customer;
generate, using a second large language model, a summary of each of the one or more support documents, wherein an input to the second large language model comprises a support document of the one or more support documents; and
provide the generated one or more summaries of the one or more support documents to the support agent for use by the support agent to mitigate the issue experienced by the customer.

19. The non-transitory, computer-readable storage medium of claim 18, wherein generating the one or more summaries of the one or more previous support encounters is performed before determining the intent of the customer, wherein the intent of the customer is determined based on the one or more summaries of the one or more previous support encounters.

20. The non-transitory, computer-readable storage medium of claim 18, wherein the data related to the request for the support encounters comprises one or more of: public information, internal information, or an intent indicated by the customer,
wherein the public information comprises information related to at least one of a weather event, an emergency, a gathering, a software update, or a hardware release,
wherein the internal information comprises information related to at least one of a service interruption of the telecommunications service or a customer bill.
